(19) United States
(12) Patent Application Publication
(10) Pub. No.: US 2026/0005281 A1
(43) Pub. Date: Jan. 1, 2026

(54) APPARATUS AND METHOD FOR INTEGRATING A PLURALITY OF FUEL CELL MODULES

(71) Applicant: SOLYDERA S.P.A, Mezzolombardo (Trento) (IT)

(72) Inventors: Massimo BERTOLDI, Mezzolombardo (Trento) (IT); Daniele LANER, Mezzolombardo (Trento) (IT); Sergio CESCHINI, Mezzolombardo (Trento) (IT)

(21) Appl. No.: 19/112,125

(22) PCT Filed: Sep. 20, 2023
(86) PCT No.: PCT/IB2023/059303

§ 371 Date: Mar. 14, 2025

(30) Foreign Application Priority Data
Sep. 20, 2022 (IT) 102022000019281

(51) Int. Cl. H01M 8/249; H01M 8/04082; H01M 8/2404; H01M 8/2475

(52) U.S. Cl. CPC H01M 8/249; H01M 8/04201; H01M 8/2404; H01M 8/2475

(57) ABSTRACT

The present invention relates to an apparatus for the connection and supply of a plurality of modules for producing electrical energy and provided with at least one stack of fuel cells.

### TECHNICAL FIELD OF THE INVENTION

The present invention relates to an apparatus and method for integrating a plurality of fuel cell modules for electric generation with the aim of ensuring a compact and highly reliable solution.

### STATE OF THE PRIOR ART

Many technical solutions have been proposed for the production of electricity with fuel cells, even in the field of cogeneration or trigeneration operation solutions.

However, these are often applications with low specific power (kW per m2) and are complicated and/or expensive to maintain, actually not optimized, if not completely incompatible with the requirements required in different installation situations.

Furthermore, with the solutions proposed so far, it is difficult to replace components subject to failure, wear and/or degradation, unless interventions involving high times and costs, with a negative impact on the availability of power guaranteed by the system.

It should also be noted that currently the electricity grid is often used as a backup, in the sense that when the energy production unit fails in whole or in part, energy from the electricity grid must be used.

Furthermore, with the solutions proposed so far, it is necessary to provide batteries or other electrical energy storage solutions, necessary in the event that the network current were to be interrupted, even temporarily, in order to avoid service interruptions and manage connection transients and disconnection of generators.

W02010043767A1 and US2019190053A1 teach two solutions according to the state of the prior art.

### SUMMARY OF THE INVENTION

An object of the present invention is to provide a new apparatus for connecting and powering a plurality of electric energy production modules based on fuel cells.

Another object of the present invention is to provide an apparatus as aforementioned to which electrical energy production modules can be connected and disconnected quickly and easily.

Another object of the present invention is to provide an apparatus in which it is possible to access the components easily.

Another object of the present invention is to provide an apparatus as indicated above which is easy to maintain and manage.

Another object of the present invention is to provide an apparatus as indicated above which is easy to assemble and transport.

Another object of the present invention is to provide an energy production unit comprising an apparatus as well as a plurality of electrical energy production modules.

Another object of the present invention is to provide an apparatus that allows continuous generation of electrical power without interruption such as to satisfy the typical data center requirement of high power availability, for example equal to 99.999%, even in the absence of the backup electricity grid.

Another object of the present invention is to provide an apparatus and a unit in which periodic maintenance of the water and gas filters can also be carried out without having to access the individual modules.

Another object of the present invention is to generate a unit in which access for connection-disconnection or insertion-disconnection of respective modules occurs from above or from the front, so that the other faces or sides remain free to minimize space of installation, being it possible to place them against each other or against a wall, thus maximizing the specific power (kW/m2).

In accordance with an aspect of the invention, an apparatus is provided for the connection and power supply of a plurality of modules for producing electrical energy according to the present application.

The present application refers to preferred and advantageous embodiments of the invention.

### BRIEF DESCRIPTION OF THE DRAWINGS

Other characteristics and advantages of the invention will be more evident from the description of an embodiment of an apparatus, illustrated by way of example in the attached drawings in which:

FIGS. 1 and 2 are perspective views from above and below, respectively, of an apparatus and unit according to the present invention,

FIGS. 3 to 10 illustrate respective details on an enlarged scale of a unit according to the present invention,

FIG. 11 is a slightly top perspective view of parts of a unit according to the present invention,

FIG. 12 is a perspective view of a possible electric energy production module equipped with at least one fuel cell stack that can be used in a unit according to the present invention,

FIG. 13 schematically shows the components of a possible electrical energy production module equipped with at least one fuel cell stack that can be used in a unit according to the present invention,

FIGS. 14 and 15 show a unit in accordance with the present invention housed in a container,

FIG. 16 shows an embodiment of a module for a unit of FIGS. 14 and 15 during connection to a respective station,

FIGS. 17 and 18 show steps of positioning a module in a position of another unit according to the present invention,

FIGS. 19 and 20 show an embodiment of a module for a unit of FIGS. 17 and 18 during connection to a respective station;

FIGS. 21 and 22 show a variant according to the present invention, according to which the modules are constrained and connected at the top; and

FIG. 23 shows a unit in accordance with the present invention according to the variant of FIGS. 21 and 22 housed in a container.

In the attached drawings, identical parts or components are identified by the same reference numbers.

### DETAILED DESCRIPTION

With reference to the attached figures, an apparatus 1 according to the present invention has been illustrated for the connection and power supply of a plurality of electrical energy production modules 2, which in some cases can also operate in cogeneration or trigeneration mode, which are equipped with at least one fuel cell stack 3.

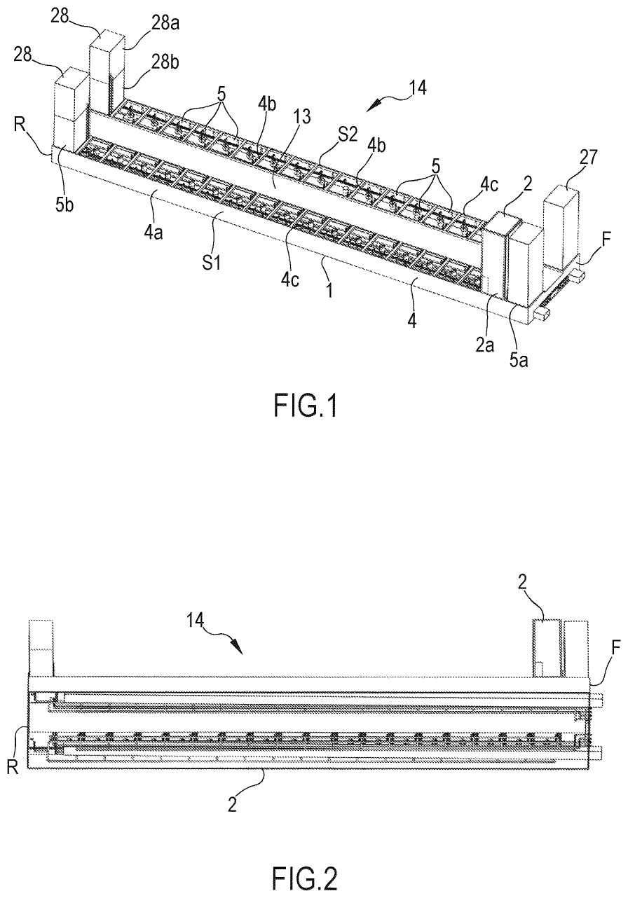

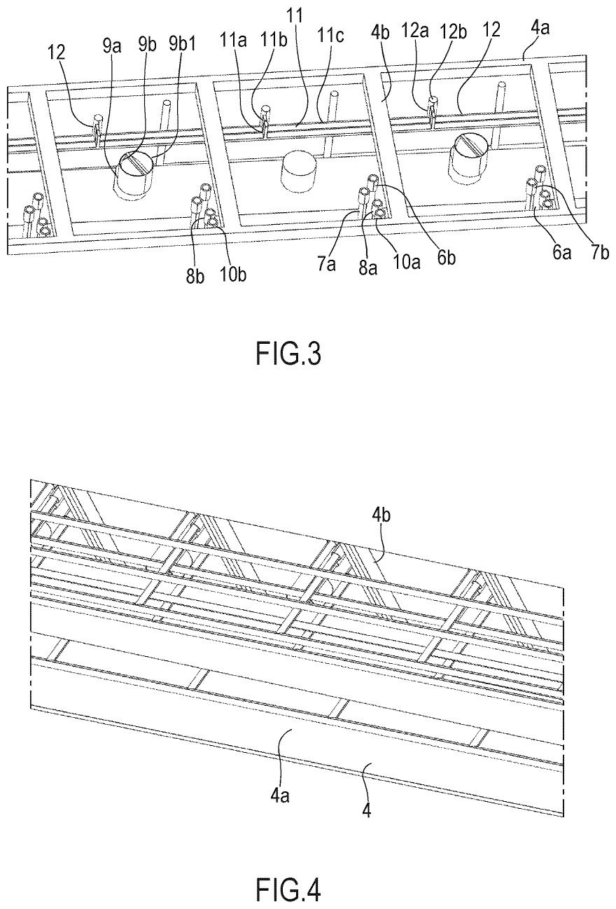

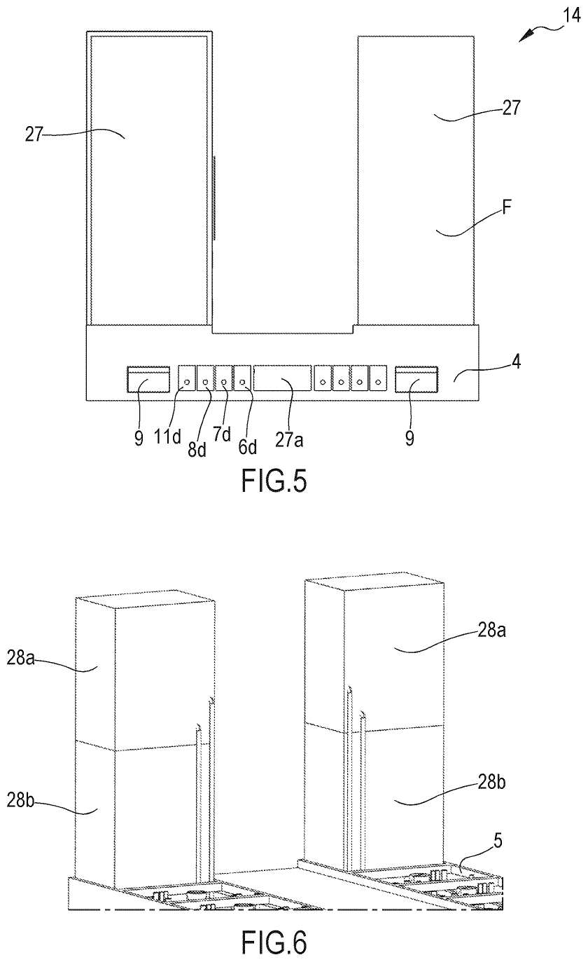

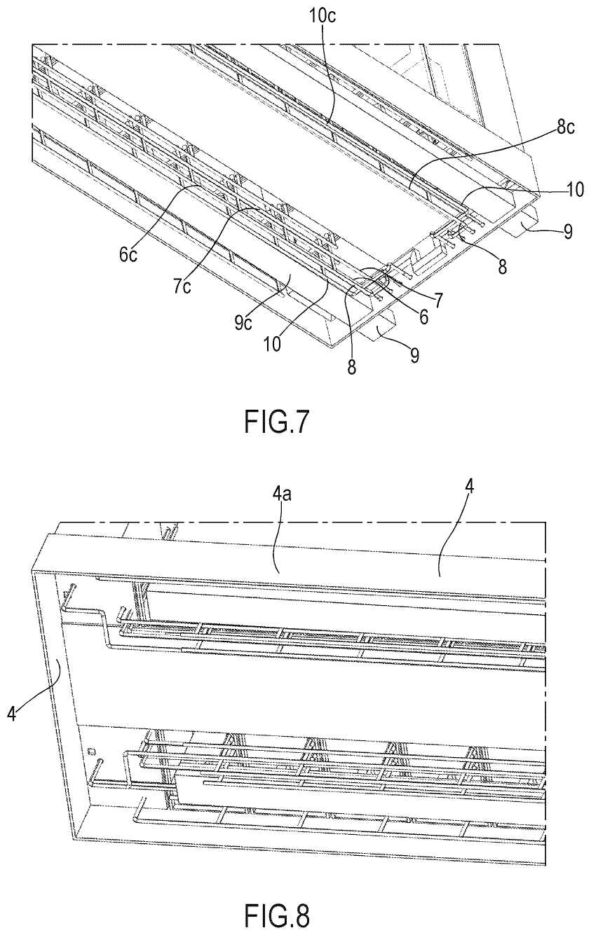

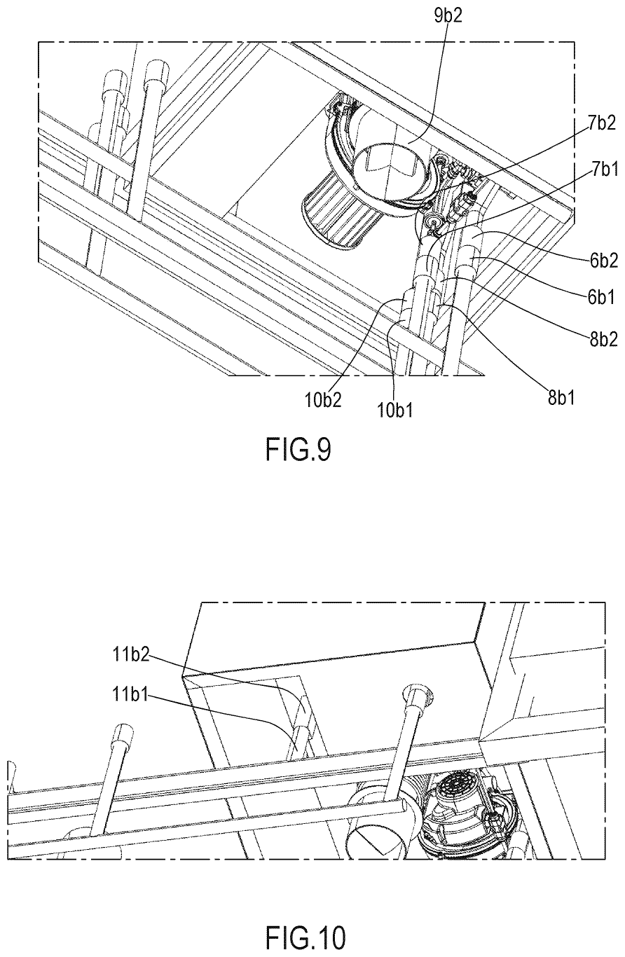

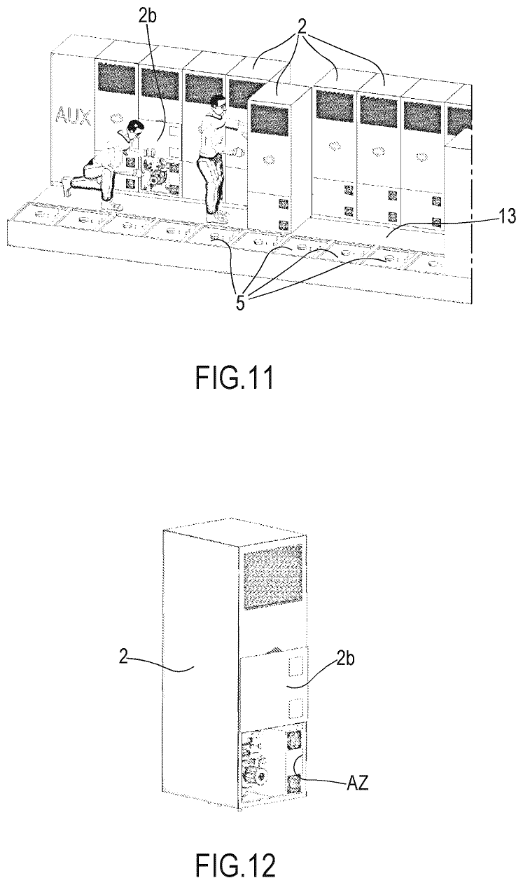

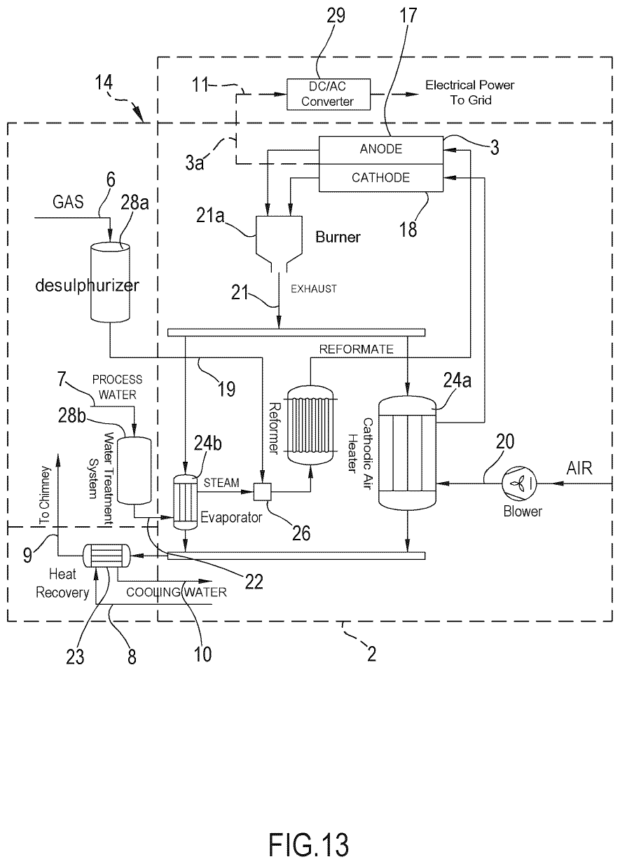

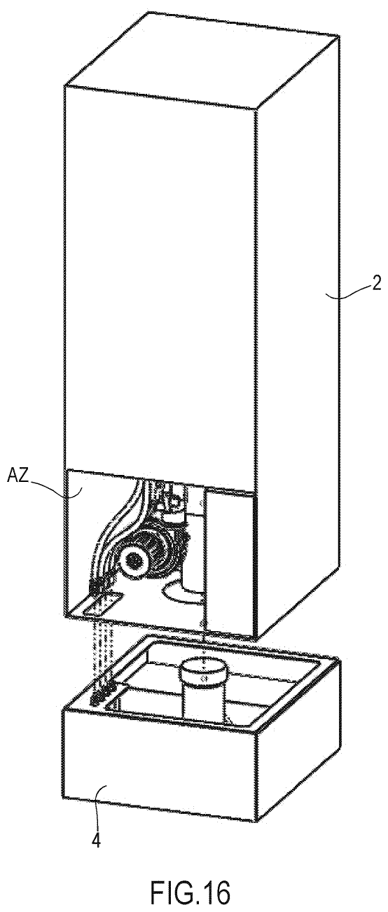

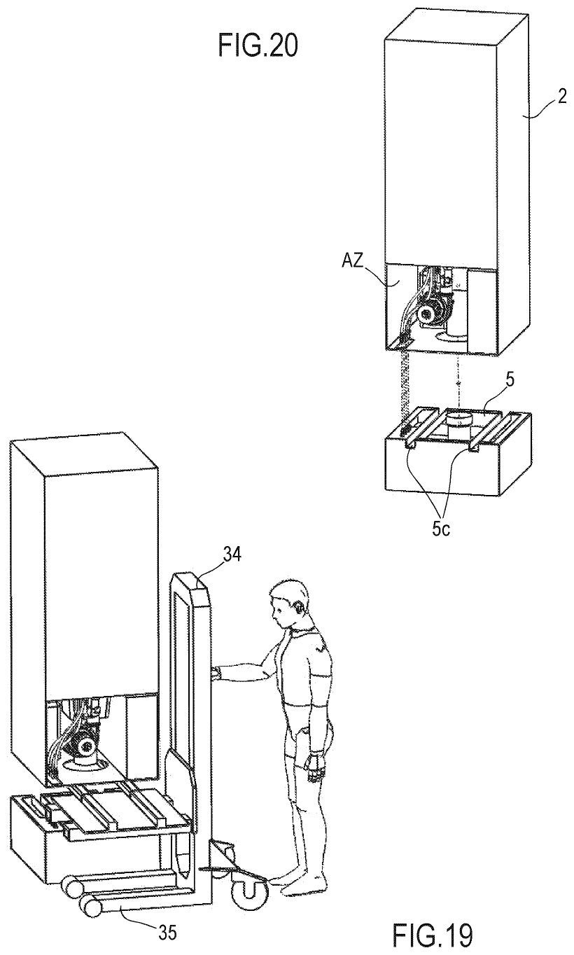

The apparatus 1 includes (see in particular FIGS. 1 to 20) in detail a main base 4 defining a plurality of stations 5 each for positioning above them and connecting at least one module 2 for the production of electric energy.

Preferably, at least one series or row of stations 5 aligned one after the other is provided.

The apparatus 1 can include a front F, a rear R and two sides S1, S2.

The apparatus 1 is then provided with a series of inlet ducts 6, 7, 8 for fluids, liquids and/or gases in the apparatus and outlet ducts 9, 10 for fluids, liquids and/or gases from the apparatus as well as one or multiple cables 11 for conveying the electrical energy produced by the modules 2, which ducts 6-10 and cables 11 are housed within the base 4.

The apparatus 1 then includes, still housed within the base 4, branches 6a-11a, if desired with a mainly vertical extension direction, of each of the ducts 6-10 and cables 11 in each of the stations 5 as well as coupling means 6b-11b of the latter to respective components of an electrical energy production module 2 with at least one fuel cell 3.

The base 4 can be made of at least one sheet or plate, for example metallic, shaped, for example following bending and/or welding and/or bolting and/or screwing so as to define a portion of the perimeter frame 4a, if desired with rectangular plan, and a plurality of crosspieces 4b connecting two portions of the base 4 and designed to define the stations 5 which are open at least partly upwards for the positioning and connection of modules 2.

Of course, the sheet or plate can be obtained with any suitable process, for example molding, extrusion, etc.

Therefore, the base 4 is not made up of a concrete block.

Advantageously, the base 4 is prefabricated or preassembled and then delivered to the installation site already mounted or assembled, i.e. after the appropriate bending and/or welding and/or bolting and/or screwing have been done.

If the base 4 is made of at least one sheet or plate as indicated above, it is clearly easier to transport (even in a container if desired, as will be said later) and changeable.

The portion of the perimeter frame 4a can be obtained by means of sections of wall with a vertical, in use, arrangement.

According to the non-limiting embodiment shown in the figures, the crosspieces 4b extend in the direction from one side of the base 4 to the other, at the top thereof.

Clearly, the base 4 could also be modular, thus with a plurality of components placed side by side and appropriately connected, each designed to define one or more stations 5. In this case, windows could be provided for the passage of the ducts/cables in the components of the base 4.

The coupling means 6b-10b of one or more ducts 6a-10a can include automatic or quick coupling means or joints, which are hydraulic or pneumatic depending on the fluid (gas, water, oil) that flows in the respective duct.

The coupling means 11b of one or more cables 11 or branch 11a can instead include electrical automatic or quick coupling means.

These automatic or quick coupling means 6b-11b include, for example, a first element or connector 6b1-11b1 constrained or fixed on one end of a duct 6-10 or cable or copper bar or bus 11 or better of a respective branch 6a-11a and a second element or connector 6b2-11b2 constrained or fixed or integral with a module 2 or better on one end of a duct or cable thereof for conveying a fluid or current inside it.

Clearly, the second element 6b2-11b2 can be inserted quickly and easily, for example by applying appropriate pressure, to the first element 6b1, 11b1.

Alternatively, attachment means of another type could be provided, for example with a valve or similar to interrupt the transfer of fluid. Clearly, even in the case of a quick coupling, this, depending on the type, could include a flow interruption valve.

In the case of the exhaust pipes or ducts 8, a valve is advantageously provided, in particular a check valve, for example a butterfly valve, a clapet valve or a valve of another type which must naturally be closed before a module 2 is disconnected from a respective station 5, to avoid waste fluids from escaping.

Of course, some or all of the stations 5 can be substantially identical to each other and thus with the same configuration, for example substantially square or rectangular, with the respective branches 6a-11a or first elements or connectors 6b1-11b1 accessible from them, so that it is possible to position and connect identical modules 2 at a plurality of stations 5.

If desired, one, some or all of the quick or automatic joints or connections of the ducts 6-10 are provided with an automatic valve, of any suitable type, for example butterfly, ball, needle, etc., mounted inside them and designed to close the passage through it when the two elements 6b1-10b1, 6b2-10b2 of the respective quick joint or coupling are disconnected and to open the passage through it when the two elements 6b1-11b1, 6b2-11b2 of the respective quick joint or coupling are connected.

Advantageously, one, some or all of the quick or automatic joints or coupling of the cables 11 are provided with interruption means or switches, of any suitable type mounted inside them and designed to close the passage of energy through them when the two elements 11b1, 11b2 of the respective quick joint or coupling are disconnected and to open the passage of energy through them when the two elements 11b1, 11b2 of the respective quick joint or coupling are connected.

Furthermore, the ducts 6-10 and cables 11 can lead or be all open on one side, with the respective branches 6a-11 a, at the stations 5 and on the other at the same side of the base, more particularly of the front F of the same. In relation to this aspect, studs or the like 6d, 7d, 8d, 10d, 11d can be inserted into the front end of the base 4, with fittings provided in the studs for the connection of respective pipes to the ends of the ducts 6, 7, 8, 10 and 11.

Alternatively, the ducts or cables could also lead towards one side and/or towards the bottom of the base 4, or some on one side and others on another part of the base 4.

In relation to this aspect, one or more of the ducts 6-10 and/or the cables 11 can thus include a manifold section 6c-11c, if desired with a mainly extension direction horizontal or slightly inclined with respect to the horizontal, from which the branches 6a-11a depart.

Of course, the various manifold sections 6c-11c extend within or below the base 4 and can extend for example in the direction from the front F to the rear R.

If desired, the base 4 defines at least two rows 4c of stations 5 separated from each other by a walkway or corridor 13 designed to allow walking between the rows 4c. In this case, the crosspieces 4b, if provided, extend between the portion of the perimeter frame 4a and the walkway or corridor 13.

Clearly, one row of modules only could be present or anyway the walkway or corridor could be absent.

With reference to this aspect, the apparatus 1 is also provided with means 12b for attachment, for example automatic or quick, of the electrical conductors 12 or of respective branches 12a in the stations to a respective part or cable of the modules 2. In this case, a first element or connector would be provided constrained or fixed on one end of a respective branch 12a and a second element or connector constrained or fixed or integral with a component which will be discussed in greater detail later.

Subject-matter of the present invention is also an energy production unit 14 comprising an apparatus 1 as well as a plurality of electrical energy production modules 2, each mounted at a respective station 5 and with respective ducts or cables connected to ducts and cables at the respective station 5.

Therefore, each module 2 can be removably connected to a respective station 5 and can also be moved or transported as a single component, thus not following demounting or disassembly of the module itself.

A module 2 usable within the scope of the present invention comprises one or a plurality of fuel cells 3 designed to supply electrical energy, via one or more supply cables 3a. Clearly, the cable(s) 3a is/are connected, by means of coupling means 11b to at least one cable 11 or to at least one respective branch 11a.

In this regard, a module 2 could include for example at least one cell 3 with anode 17 and cathode 18, a first line 19 for conveying combustible fluid, such as reaction fuel gas to the anode 17 and a second line 20 for conveying air to the cathode 18, as well as discharge lines 21 from the cathode 18 and the anode 17.

If desired, such a module 2 also includes at least one duct 22 for supplying process water in the first line 19.

Therefore, the modules 2 are designed to be powered by a fuel and, if desired, water and/or air or other fluid and to generate electrical energy, if desired at a respective fuel cell 3.

Of course, one, some or each line 19, 21, 22 of each module 2 is connected to a respective duct 6, 9 and 7 of the apparatus or to a respective branch 6a-9a, for example by means of respective coupling means 6b-9b.

If desired, the modules 2 or the unit 14 with which they are associated are/is cogenerative, and thus they produce not only electrical energy but also thermal energy, in the event that the heat transferred to the water is recovered and used.

In this regard, at least one module 2 or the unit 14 can include at least one heat exchanger 23 designed to connect an intermediate or final section of the exhaust line 21 or of the exhaust duct 9 of the apparatus and a line or ducts 8, 10 for conveying cooling water or fluid.

Alternatively they could be trigenerative, in which case the heat produced by the generator in an absorption chiller is used to generate low temperatures in specific environments and reduce the electricity consumption corresponding to the cooling generated.

A module 2 can also include other components, such as:
a burner 21a designed to burn the discharges of the anode 17 and cathode 18, and/or
a heater 24a of a fluid, such as air, entering the cell 3, for example at the cathode, which heater 24a can for example include a heat exchanger designed to put the line 20 in communication with the line 21, and/or
an evaporator 24b to determine the evaporation of a fluid, such as water on the line 22, which evaporator 24b can for example include a heat exchanger designed to put the line 22 in communication with the line 21, and/or
an ejector or mixer 26 designed to mix or combine the fuel supplied along the line 19 and a fluid, such as water supplied along the line 22.

Such a cogeneration or trigeneration module 2 can have any suitable configuration.

One or more modules 2 can include a casing with a box-like or cabinet configuration, preferably parallelepiped or cuboid, which is arranged with the respective base 2a mounted on top of a respective station 5.

In this case, the base 2a could delimit at least one opening facing, in use, downwards so as to allow the connection of the ducts and cables 3a, 19, 21, 22 of the module 2 with the ducts 6, 7, 9 or cables 11 or respective branches 6a, 7a, 9a, 11a of the apparatus 1.

With regard to this aspect, the modules 2 can also have at least one panel, for example front panel 2b, removable or in any case moveable so as to expose an zone for access AZ to the components of the module itself and, if desired, to allow the connection of the ducts 19, 21, 22 and cables 3a of modules 2 to those in a respective station 5 or to facilitate maintenance or supervision.

The panel 2b could be designed to close a lower front zone of the module 2, so that the access zone AZ would be delimited below the module 2.

In relation to this aspect, the panel 2b could be mounted with screws or other constraint means or be mounted on guides and free to slide or pivoted or made/connected in another way so as to be moveable between a closed or confined or covered position of the access zone AZ and an open position (see FIG. 12), in which the access zone AZ is exposed and accessible for connecting/disconnecting the module 2 to or in a station 5.

Alternatively or in addition, the base 4 or respective components could instead include a movable panel so as to allow access to a zone to ensure the connection of the ducts 19, 21, 22 and cables 3a of the modules 2 to those in a respective station 5 or to facilitate maintenance or supervision.

Of course, measures could also be envisaged for the mechanical constraint of the modules 2 to the base 4.

The unit 14 can then include at least one component 27 for collecting and managing the electrical energy (essentially an electrical panel) produced in the modules 2, the cables or copper bars or bus 11 extending between the stations 5 and the collection and management component 27 and, if desired from this towards a respective socket 27a, if desired at the front end of the base 4.

The copper bars or buses, as it is known, deliver the current while dispersing less energy. In this description reference has been made several times to cables for the transmission of current, but it is clearly to be understood that alternative copper bars can be used with reference to the transfer of power/energy, not for the transfer of signals.

Of course, the collection and management component 27 or other component of the unit 14 can include, among other things, one or more inverters 29 for the conversion of electrical energy from direct to alternating current.

Clearly, the apparatus 1 or the unit 14 also includes an electronic control unit or PLC responsible for controlling the various elements of the apparatus 1 or the unit 14, such as the valves.

With regard to this aspect, one or more electrical conductors 12 can also be provided in the apparatus 1 or in the unit 14, responsible for transmitting the electronic control signals from the control unit or PLC to the components of the modules 2.

The PLC can be integrated into the collection and management component 27, whereby the conductor(s) 12 for the transmission of the electronic control signals from the control unit or PLC to the components of the modules 2 can depart from the collection and management component 27.

The centralized control unit and/or that of the individuals (as well as all the elements of the modules, such as valves or other, both of the technical solution and of the control logic) can be programmed so that when a module 2 is replaced or maintained, the others continue to work and produce energy.

However, in the solutions envisaged so far, if multiple energy production modules or components are envisaged, when one module breaks or is damaged, the others working must be brought to stand-by conditions, power derating or turned off to allow the intervention of repair and/or replacement.

However, according to the present invention, this may not happen.

In relation to this aspect, the modules 2 can deliver electrical energy on the same bus or collector of the cable 11, so when a module 2 is disconnected to repair or replace it, the power or energy delivered by the other modules is increased slightly, so as to guarantee the power compensation. In this regard, according to the present invention the modules are not, unless emergency or extraordinary conditions, operated at maximum energy or power output.

This expedient ensures the possibility of generating continuous electrical power without interruption such as to satisfy the typical data center requirement of high power availability, for example greater than 90%, if desired greater than 96% or even equal to or greater than 99.999%, even in the absence of the backup electrical grip.

Even the collection and management component 27 can have a casing with a box-like or cabinet configuration, preferably parallelepiped or cuboid-shaped, for example substantially equal to the external configuration of the modules 2.

The collection and management component(s) 27 is/are always mounted above the base 4, at respective stations 5a, for example two proximal to the front F.

If desired, the unit 14 is also provided with at least one fluid filtering unit 28 mounted at one end of the base.

The filtering unit 28 can have a casing with a box-like or cabinet configuration, preferably parallelepiped or cuboid-shaped, for example substantially identical to the external configuration of the modules 2.

The filtering unit 28 is always mounted above the base 4, at respective stations 5b, for example two proximal to the rear R.

If desired, the or each filter assembly 28 can include a section 28a for filtering fuel and a section 28b for filtering water or other fluid. The section 28a for fuel filtering may include for example a desulfurization station, which would therefore be shared for all modules 2 of unit 14.

If one uses hydrogen and in the absence of sulfur-based odorants, there would be no need for the desulfurizer. The desulfurizer is used if mains natural gas, or biogas or biomethane is used, to filter the sulfur-based components present in natural gas with sulfur-based odorants.

Clearly, if at least one filtering group 28 is present, the ducts for conveying the fluids, liquids and/or gases, to be filtered will have a first section for transporting the fluid from the outside to the filtering group 28 and then a second section from the latter to the modules 2 or better yet to a manifold which then distributes the fluid to the branches.

Thanks to this configuration, it will be understood that it is possible to carry out periodic maintenance of the water and gas filters, without having to access the individual energy production modules, this being mainly due to the fact that the filters have been provided externally to the modules and such as to serve all or more modules, obviously providing the necessary redundancies and bypasses in order to ensure continuous operation of the apparatus.

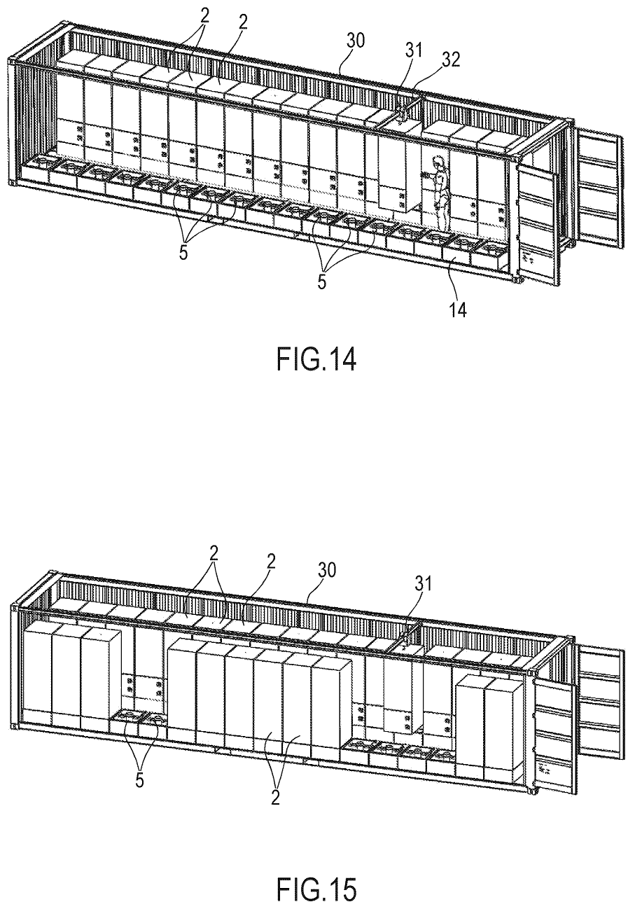

A unit 14 according to the present invention can have an overall configuration such that it can also be housed in a container or intermodal container 30 (see FIGS. 14 and 15), for example 40 feet.

Subject-matter of the present invention is also a unit housed within a container 30.

In this case, the movement of the modules 2 could be achieved in any suitable way, for example by means of an overhead crane or similar 31 or a trolley 34, is desired an automatic or not forklift.

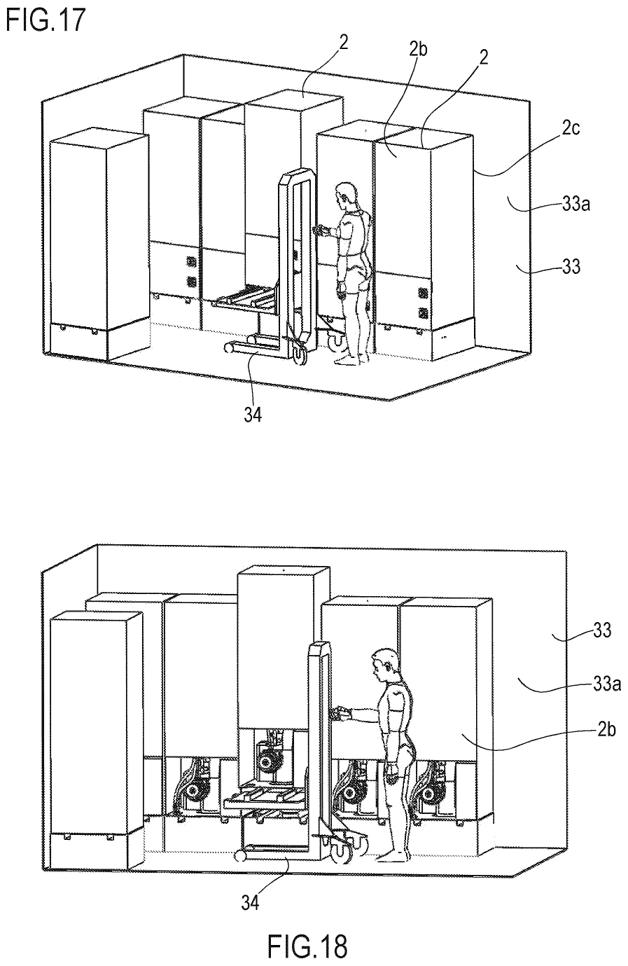

Clearly, a unit 14 according to the present invention can also be installed in another operating environment, for example in a room or in a technical room 33 (see FIGS. 17 and 18). In this case, the modules 2 can be arranged in any suitable way, for example with respective rear walls 2c or backs in contact with each other, or placed against a wall 33a of the technical room.

According to this variant, the movement of the modules 2 could be achieved in any suitable way, for example by means of a forklift or a trolley 34, if desired an automatic or not forklift, or even with another system.

As regards the version with the overhead crane 31, with reference to the embodiment of a unit housed within a container, a rod 32 or the like could be provided, slidably mounted with respect to a frame or upper structure of the container 31 or technical room 33, which rod 32 supports the head of an overhead crane 31 carrying for example a wire or cable or rope with a hook or similar at the lifting or gripping end of the modules 2. Relatively in particular to the version with forklift 34, special expedients will have to be clearly provided to allow the same component to pick up a module 2 and place it appropriately above a respective station 5.

Thus for example, a station 5 could define seats 5c open upwards designed to allow the lowering of the forks 35 of a trolley 34 into them and thus the extraction of the trolley 34 once a module 2 has been placed on a respective station 5.

Clearly, the base 4 and thus the respective stations 5 can be recessed into the floor of a technical room or even mounted on it and protruding upwards from it.

An apparatus 1 and a unit 14 according to the present invention can be used for any type of application in which electrical energy with high reliability is required, for example data centers, banks, supermarkets, plants, such as refrigeration plants or of other types or also in general as a total or partial replacement of energy supply groups, such as UPS.

In accordance with the present invention, a method is also provided for the connection and power supply of a plurality of electrical energy production modules 2, which involves arranging an apparatus 1 as indicated above and then transporting, positioning and connecting one or more modules 2 on or in the various stations 5 in such a number as to guarantee the desired electrical energy.

Of course, the connection step of each module 2 is carried out by placing it above or partially within a station 5 and then connecting the various coupling means, for example quick or automatic coupling means.

In this regard, the transport step is carried out in any suitable way, for example by means of an overhead crane 31 or a manually or automatically guided forklift 34, for example with forks and/or shovels.

As mentioned, advantageously the base 4 or the frame or top component 37 is prefabricated or pre-assembled and then delivered to the installation site already assembled or assembled.

If desired, the modules 2 could be transported in an apparatus 1 or unit 14 according to the present invention by means of an automatically guided device or shuttle, for example capable of supporting 500 kg.

In relation to this aspect, if a walkway or corridor 13 is provided, the operators or the shuttle or the overhead crane or the trolley could operate for the positioning, connection and maintenance of the modules 2 while staying in the walkway or corridor 13. In this case, the modules 2 would be moved or dragged or moved in the walkway 13 and between this (transversally) and the stations.

Subsequently, it would be possible to move, for example upwards, any panel 2b to access the access zone AZ.

Following this step, one or more modules 2 or rather the respective ducts and cables are easily connected to those in the respective station 5.

Furthermore, as has been discussed, it is possible to access for connection-disconnection or insertion-disconnection of respective modules from above or from the front, so that the other faces or sides remain free to minimize the installation space, being able to place them against each other or against a wall.

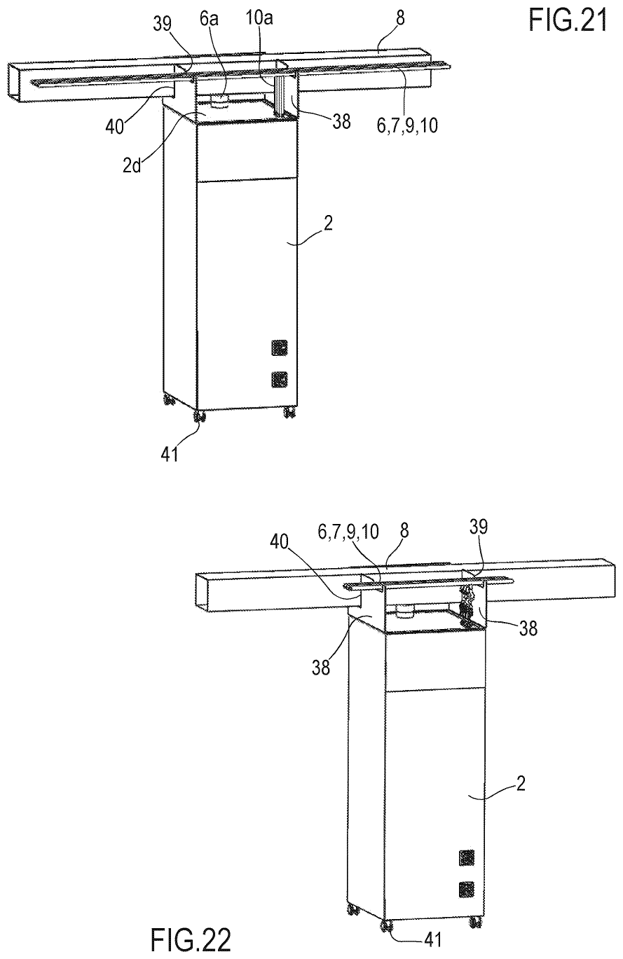

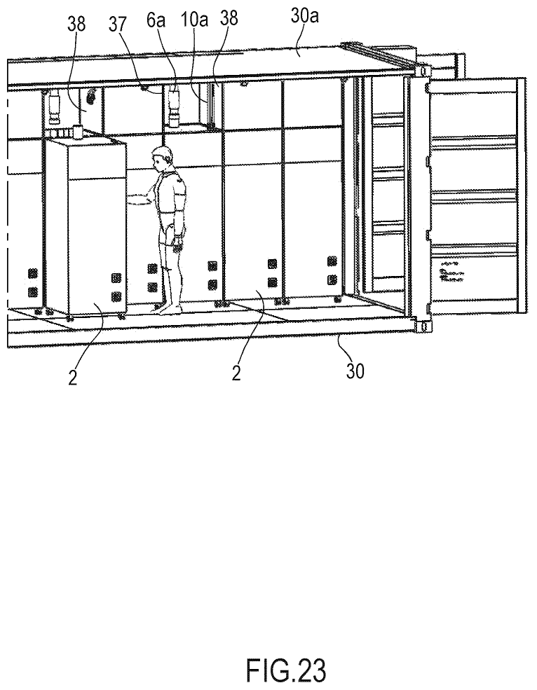

With reference then to FIGS. 21 to 23, they illustrate a variant in accordance with the present invention in which the modules 2 are constrained and connected to stations 5 which are at the top or above the modules themselves and which are thus open completely or partially at least partly downwards for the positioning under them and then the connection of modules 2. Of course, for this variant essentially the same advantageous characteristics described with reference to the embodiment of FIGS. 1 to 20 apply.

In accordance with this variant, the apparatus includes a series of ducts 6-9 for inlet of fluids into the apparatus and for outlet 10 of fluids from the apparatus as well as at least one cable 11 for conveying electrical energy produced by the modules 2 which are provided at the top or in any case in a high position of the apparatus itself, and there are then provided, always at the top or in any case in a high position, branches 6a-11a of each of the ducts 6-10 and at least one cable 11 in each of the stations 5 as well as means of connection 6b-11b of the latter to respective components of one or more electrical energy production modules 2.

Of course, the branches 6a-11a extend downwards from the respective duct or cable and have a lower connection end.

With regard to this aspect, the apparatus 1 can or can not include a frame or support component or top socket 37 defining the stations 5 open or defining at least one opening at least downwards.

Thus for example, by way of non-limiting example, the frame 37 could include vertical walls 38 fixed, in any suitable way, to an upper wall 30a of a technical room or of a container 30 or of a room in general or even of the apparatus itself and which extend up to a height corresponding to or slightly higher than the height of the modules 2.

Similarly to what is indicated for the base 4, the frame or support component or top socket 37 could be made of one or more sheets or plates, for example made of metal. Furthermore, the frame or top component 37 could be prefabricated or preassembled and then delivered to the installation site already assembled or assembled.

If desired, each station 5 can be defined between two lateral vertical walls 38, in which case adjacent stations 5 could have a common vertical wall 38.

These vertical walls 38 could then define windows or seats 39, 40 at the top for the passage of ducts or cables.

The stations could also be defined by a wall of a container or technical room, which could constitute the bottom or back of a station 5.

As regards the front of a station (which does not correspond to the front of the apparatus or unit), it could be opened or, if desired, closed using a panel, as will be explained later.

According to this variant, the modules 2 would be transported, positioned and connected under the plurality of stations 5 in such a number as to guarantee the desired electrical energy.

Of course, the connection step of each module 2 is carried out by placing it under a station 5 and then connecting the various coupling means, for example quick or automatic coupling means.

In this regard, the modules 2 with their respective side walls can be brought into a position within the horizontal encumbrance of the vertical walls 38 of the respective stations 5, that is to say that each module 2 is arranged in the vertical projection space of the zone defined between the adjacent vertical walls 38.

According to this variant, the ducts and cables 3a, 19, 21, 22 of the module 2 protrude upwards or in any case can be engaged or connected from above for the connection with the ducts 6, 7, 9 or cables 11 or respective branches 6a, 7a, 9a, 11a of the apparatus 1.

In this regard, the transport step is carried out in any suitable way, for example with a manually or automatically guided trolley, optionally with forks and/or shovels or alternatively the modules 2 could also be provided with wheels 41 at the bottom for sliding modules 2 along corridors or similar and then, once module 2 has been placed under a station 5, connect them easily or better by connecting the respective ducts, cables to those in the respective station 5. This clearly applies to all modules 2.

Of course, even in this case a movable panel 2b could be provided to hide the access zone AZ.

Clearly, the movable panel could be provided in the modules 2 or even in the top of the apparatus, if desired in a top component or socket or in a frame of the same.

Thus for example, the frame 37 can include a panel 37a mounted with screws or other constraint means or be mounted on guides and free to slide or pivoted or made/connected in another way to the frame 37 or to respective vertical walls 38, thus to be movable between a closed or confined or coverage position of the access zone and an open position.

Modifications and variations of the invention are possible within the scope defined by the claims.

1. An apparatus for the connection and supply of a plurality of modules for producing electrical energy and provided with at least one stack of fuel cells, said apparatus comprising a main base or a frame or top component defining a plurality of stations each for positioning above or below them and the connection of at least one module for producing electrical energy, said apparatus further comprising a plurality of ducts housed within said base or frame or top component and arranged for the inlet of fluids into the apparatus and the outlet of fluid from the apparatus as well as at least one cable for conveying the electrical energy produced by the modules, said apparatus further comprising, always housed within said base or frame or top component, branches of each of said ducts and at least one cable in each of said stations as well as means for coupling the latter to respective components of a module for producing electrical energy,
wherein said base or frame or top component is made of at least one folded and/or welded and/or bolted and/or screwed sheet or plate.

2. The apparatus according to claim 1, wherein said base or frame or top component defines a portion of perimeter frame and a plurality of crosspieces connecting two portions of the base and designed to define said stations which are open at least partially upwards or downwards for the positioning and connection of modules for producing electrical energy.

3. The apparatus according to claim 1, wherein the coupling means of one or more ducts and/or one or more cables are automatic or quick coupling means or joints.

4. The apparatus according to claim 3, wherein said automatic or quick coupling means or joints comprise a first element or connector constrained or fixed on one end of a duct or cable and a second element or connector that can be constrained or fixed with a module or rather on one end of a tube or cable of the same for conveying a fluid or current inside it, said second element being inserted to the first element, and
wherein said automatic or quick coupling means or joints comprise an automatic valve or cut-off means or switch means mounted within said automatic or quick coupling means or joints and adapted to close the passage of fluid or energy therethrough when the two elements of the respective automatic or quick coupling means or joints are disconnected and to open the passage through them when the two elements are connected.

5. Apparatus The apparatus according to claim 1, wherein said base defines at least two rows of stations separated from each other by means of a walkway or corridor designed to allow walking between said rows.

6. The apparatus according to claim 1, wherein said ducts and cables lead to or are all open at the same side of the base or frame or top component.

7. A unit for producing energy comprising the apparatus according to claim 1, as well as a plurality of electric energy production modules each mounted at or above or below a respective station and with respective pipes or cables connected to ducts and cables at the respective station.

8. The unit according to claim 7, wherein at least one module of said plurality of modules comprises at least one fuel cell stack designed to deliver electrical energy through one or more supply cables, said at least one fuel cell stack comprising anode and cathode, said unit further comprising a first line for conveying reaction fuel gas to said anode and a second line for conveying air to said cathode, discharge lines from said anode and from said cathode.

9. The unit according to claim 8, wherein said at least one module comprises at least one duct for supplying process water in said first line.

10. The unit according to claim 7, wherein at least one module defines at least one opening facing, in use, downwards or upwards, so as to allow the connection of the ducts and cables of this module with the ducts or cables or respective branches of the apparatus.

11. The unit according to claim 7, wherein at least one module or said base or said frame or top component comprises at least one panel which is removable or in any case movable so as to expose an access zone (AZ) to allow the connection of the ducts and cables of a module to those in a respective station.

12. The unit according to claim 7, comprising a component for collecting and managing the electrical energy produced in the modules, said cables extending between said stations and said collection and management component.

13. The unit according to claim 7, comprising at least one group for filtering fluids mounted at one end of the base or of said frame or top component.

14. The unit according to claim 7, comprising a control unit designed to control elements of the apparatus or of the unit.

15. The unit according to claim 14, wherein said control unit is set so that when one module is disconnected for replacement or maintenance, the other modules continue to work and produce energy.

16. Intermodal container comprising a unit according to claim 7 housed therein.

17. A method for connecting and powering a plurality of electrical energy production modules, which includes the following steps:
providing the apparatus according to claim 1,
transport, position and connect one or more modules in or above or below the stations.

18. The method according to claim 17, wherein said base or frame or top component is prefabricated or preassembled and then delivered to the installation site already mounted or assembled.

19. The method according to claim 17, with an apparatus for the connection and supply of a plurality of modules for producing electrical energy and provided with at least one stack of fuel cells, said apparatus comprising a main base or a frame or top component defining a plurality of stations each for positioning above or below them and the connection of at least one module for producing electrical energy, said apparatus further comprising a plurality of ducts housed within said base or frame or top component and arranged for the inlet of fluids into the apparatus and the outlet of fluid from the apparatus as well as at least one cable for conveying the electrical energy produced by the modules, said apparatus further comprising, always housed within said base or frame or top component, branches of each of said ducts and at least one cable in each of said stations as well as means for coupling the latter to respective components of a module for producing electrical energy,
wherein said base or frame or top component is made of at least one folded and/or welded and/or bolted and/or screwed sheet or plate,
wherein said base or frame or top component defines a portion of perimeter frame and a plurality of crosspieces connecting two portions of the base and designed to define said stations which are open at least partially upwards or downwards for the positioning and connection of modules for producing electrical energy,
wherein the step of connecting each module is carried out by placing it above or partially within or below each station and then connecting the automatic or quick coupling means or joints.

20. The method according to claim 16, wherein said modules are transported in said apparatus by means of an automatically guided device or shuttle or an overhead crane or forklift or said modules are sliding on wheels.

21. The method according to claim 17, wherein an electronic control unit is provided for controlling elements of the apparatus or of the modules, and
wherein the modules deliver electrical energy on the same bus or collector, so when a module is disconnected to repair or replace it, the power or energy delivered by the other modules is increased slightly, so as to guarantee the power compensation, the modules are not, unless emergency or extraordinary conditions, operated at maximum energy or power output.
